(19) United States
(12) Patent Application Publication
(10) Pub. No.: US 2019/0139280 A1
(43) Pub. Date: May 9, 2019

(54) AUGMENTED REALITY ENVIRONMENT FOR TABULAR DATA IN AN IMAGE FEED

(71) Applicant: Microsoft Technology Licensing, LLC, Redmond, WA (US)

(72) Inventor: Olaf HUBEL, Redmond, WA (US)

(21) Appl. No.: 15/804,601

(22) Filed: Nov. 6, 2017

(51) Int. Cl. G06T 11/60; G06T 11/20; G06K 9/00; G06N 5/04; G06N 99/00

(52) U.S. Cl. CPC G06T 11/60; G06T 11/206; G06K 9/00671; G06K 9/4604; G06N 5/047; G06N 99/005; G06K 2209/01; G06K 9/00449

(57) ABSTRACT

Methods, systems, and apparatuses for creating an augmented reality environment for tabular data in an image feed. One method includes receiving, with an electronic processor included in a user device, the image feed from an image sensor included in the user device and automatically detecting tabular data within the image feed. The method also includes automatically detecting data patterns within the tabular data, automatically calculating a numerical value based on one or more values included in the tabular data and the data patterns detected within the tabular data and automatically augmenting, with the electronic processor, the image feed as displayed on a display device of the user device to include the numerical value to create the augmented reality environment.

### FIELD

Embodiments described herein relate to detecting tabular data within an image feed and creating an augmented reality environment for the tabular data within the image feed, such as by augmenting the image feed to include one or more graphical charts or calculated values based on values within the tabular data.

### SUMMARY

Spreadsheet software, such as Excel® provided by Microsoft Corporation, allows a user to create an electronic spreadsheet of values, such as numerical values. The spreadsheet software may also allow a user to generate one or more graphical charts and calculate values, such as sums, averages, counts, and the like. Creating such an electronic spreadsheet, however, takes time as a user typically must manually enter or import values into the spreadsheet. Accordingly, entering values into an electronic spreadsheet is a time-consuming task and is not practical in many situations when a user would like to analyze tabular data not already within an electronic spreadsheet. Therefore there is a need for systems and methods that automatically detect tabular data within an image feed and generate supplemental information based on the tabular data, such as graphical charts, calculations, and the like, that are provided to the user within an augmented reality environment.

Accordingly, embodiments described herein provide systems and methods for detecting and processing tabular data within an image feed to generate supplemental information regarding the tabular data that can be used to create an augmented reality environment for the tabular data. In particular, embodiments described herein automatically detect tabular data within an image feed and automatically generate a graphical chart representing the tabular data, automatically calculate one or more values based on the tabular data, identify errors in the tabular data, or a combination thereof. Embodiments described herein also augment the image feed with this generated additional data to create an augmented reality environment for the tabular data.

For example, one embodiment provides an electronic device. The electronic device includes an image sensor, a display device, and an electronic processor. The electronic processor is configured to receive an image feed from the image sensor and automatically detect tabular data within the image feed. The electronic processor is also configured to automatically, via an artificial intelligence engine, determine a type of supplemental information to generate based on the tabular data, the type of supplemental information including at least one selected from a group consisting of a calculation and a graphical chart and automatically generate supplemental information based on the determined type of supplemental information and at least one value included in the tabular data. The electronic processor is further configured to automatically augment the image feed as displayed on the display device to include the supplemental information to create an augmented reality environment.

Another embodiment provides a method of creating an augmented reality environment for tabular data in an image feed. The method includes receiving, with an electronic processor included in a user device, the image feed from an image sensor included in the user device and automatically detecting tabular data within the image feed. The method also includes automatically detecting data patterns within the tabular data, automatically calculating a numerical value based on one or more values included in the tabular data and the data patterns detected within the tabular data and automatically augmenting, with the electronic processor, the image feed as displayed on a display device of the user device to include the numerical value to create the augmented reality environment.

Yet another embodiment provides non-transitory computer-readable medium storing instructions that, when executed with an electronic processor, perform a set of functions. The set of functions includes receiving tabular data detected within an image feed captured by an image sensor included in a user device, automatically selecting a type of graphical chart from a plurality of graphical chart types based on a rule and the tabular data, automatically generating a graphical chart of the type of graphical chart selected from the plurality of graphical chart types based on values included in the tabular data, and automatically providing the graphical chart to the user device for augmenting the image feed as displayed on a display device of the user device to include the graphical chart to create an augmented reality environment.

### BRIEF DESCRIPTION OF THE DRAWINGS

FIG. 1 schematically illustrates a system for creating an augmented reality environment for tabular data in an image feed according to one embodiment.

FIG. 2 schematically illustrates a server included in the system of FIG. 1 according to one embodiment.

FIG. 3 schematically illustrates a user device included in the system of FIG. 1 according to one embodiment.

FIG. 4 is a flow chart illustrating a method of augmenting an image feed to include a numerical value calculated based on tabular data detected within in the image feed performed by the system of FIG. 1 according to one embodiment.

FIG. 5 illustrates an example image feed displayed on a display device of the user device of FIG. 3.

FIG. 6 illustrates the example image feed of FIG. 5 augmented to include a numerical value according to the method of FIG. 4.

FIG. 7 illustrates an example image feed augmented to include a graphical chart according to the method of FIG. 4.

FIG. 8 illustrates an example image feed augmented to include an indication according to the method of FIG. 4.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As noted above, embodiments described herein create an augmented reality environment for tabular data detected within an image feed with little or no user interaction. The augmented reality environment includes supplemental information for the tabular data, such as graphical charts, calculated values, indications of errors, and the like. Thus, a user is not required to manually enter tabular data represented on a piece of paper, a whiteboard, a display device, or the like into an electronic spreadsheet to process the tabular data. Rather, a user can capture an image feed of the tabular data and embodiments described herein create an augmented reality environment within the image feed to provide real-time insights for the tabular data. As used herein “augmented reality environment” includes, for example, superimposing data, such as a computer-generated image, onto a user's view of the real world, such as an image feed captured via an electronic device, to provide the user with a composite view. Also, as used herein, “supplemental information” for tabular data includes data (values, charts, and the like) derived from or determined based on the tabular data (as contrasted from the tabular data itself simply converted to an electronic format, such as an electronic spreadsheet).

The methods and functionality described herein for creating an augmented reality environment include an electronic device (a user device) accessing services through one or more servers (including servers accessible through one or more cloud services environments). However, it should be understood that the methods described herein may be used in other computer systems and configurations. For example, the methods described herein (or portions thereof) may be performed locally at an electronic device (a user device) without communicating with any remote servers or services. Accordingly, the methods and systems described in the present application are provided as one example and should not be considered limiting.

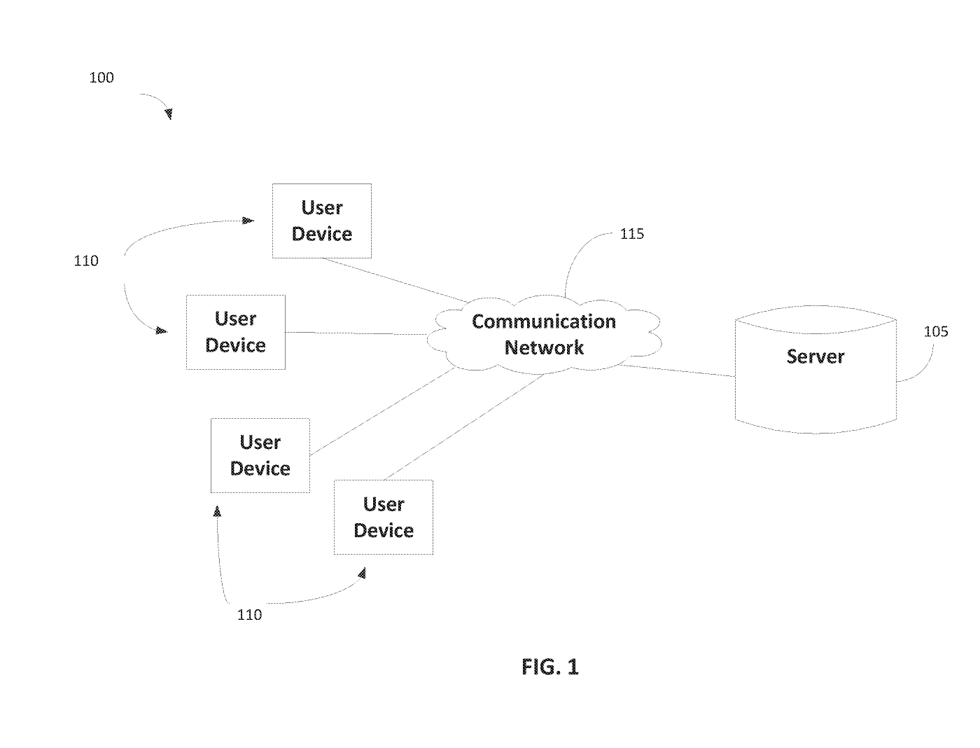

FIG. 1 schematically illustrates a system 100 for creating an augmented reality environment for tabular data detected within an image feed. As illustrated in FIG. 1, the system 100 includes a remote computer or server 105 and a plurality of user devices 110 (referred to herein collectively as “the plurality of user devices 110” and individually as “a user device 110”). The server 105 and the plurality of user devices 110 communicate over one or more wired or wireless communication networks 115. Portions of the wireless communication networks 115 may be implemented using a wide area network, such as the Internet, a local area network, such as a Bluetooth™ network or Wi-Fi, and combinations or derivatives thereof. It should be understood that the server 105 may communicate with any number of user devices 110 and the four user devices 110 that are illustrated in FIG. 1 are purely for illustrative purposes. Also, in some embodiments, a user device 110 may communicate with the server 105 through one or more interim devices.

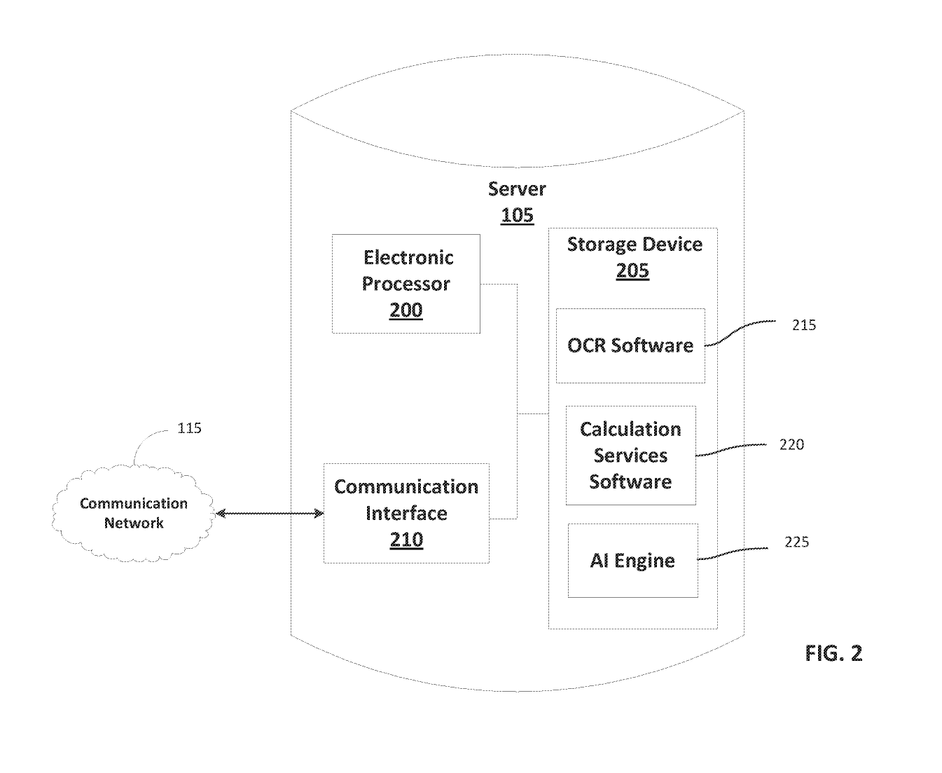

As illustrated in FIG. 2, the server 105 is an electronic device that includes an electronic processor 200 (for example, a microprocessor, application-specific integrated circuit (ASIC), or another suitable electronic device), a storage device 205 (for example, a non-transitory, computer-readable storage medium), and a communication interface 210, such as a transceiver, for communicating over the communication networks 115 and, optionally, one or more additional communication networks or connections. The electronic processor 200, the storage device 205, and the communication interface 210 communicate over one or more communication lines or buses. It should be understood that the server 105 may include additional components than those illustrated in FIG. 2 in various configurations and may perform additional functionality than the functionality described in the present application. Also, the functionality described herein as being performed by the server 105 may be distributed among multiple devices, such as multiple servers operated within a cloud environment.

The electronic processor 200 included in the server 105 executes instructions stored in the storage device 205. In particular, as illustrated in FIG. 2, the storage device 205 stores optical character recognition (OCR) software 215, calculation services software 220, and an artificial intelligence (AI) engine 225. The OCR software 215 may be a web service (accessible through an application programming interface (API)) that processes image data (including video) to detect characters, values, or other particular data within the image data. In particular, as described in more detail below, the OCR software 215 may be configured detect, in real-time, tabular data within video. For example, in some embodiments, the OCR software 215 includes the Azure® Vision API provided by Microsoft Corporation.

The calculation services software 220 may similarly be a web service (accessible through an API) that processes data, such as tabular data, including but not limited to performing calculations, generating charts, and the like. For example, in some embodiments, the calculation services software 220 includes the Excel® API provided by Microsoft Corporation that exposes functionality available with Excel®, such as calculations (functions), charts (including pivot tables), and the like, to obtain one or more calculations for the detected tabular data.

The AI engine 225 may also be a web service (accessible through an API) that processes tabular data to automatically detect data patterns in the tabular data and automatically determine one or more types of supplemental information to generate for the tabular data based on the detected data patterns and one or more rules or mappings. The rules may, for example, map particular data patterns to particular types of supplemental information, such that types of calculations, charts, or the like, to particular data patterns in tabular data. The AI engine 225 may be configured to automatically update these rules using one or more machine learning techniques, such as neutral networks. Thus, the AI engine 225 automatically gets “smarter” over time in identifying what type of data to use and what type of supplemental information to generate (for example, run calculations on, convert to graphical charts, and the like).

It should be understood that the OCR software 215, the calculation services software 220, and the AI engine 225 may be stored or distributed among multiple storage devices 205 within the server 105 (or multiple servers) and the functionality described herein as being performed by these pieces of software 215, 220, and 225 may be combined and distributed in various configurations. For example, in some embodiments, the storage device 205 stores a single piece of software that performs both the tabular data detection, described herein as being performed by the calculation services 220, and the functionality described herein as being performed by the AI engine 225. In other embodiments, each piece of software 215, 220, and 225 (each API) is implemented as a separate web (cloud) services running independently on separate servers.

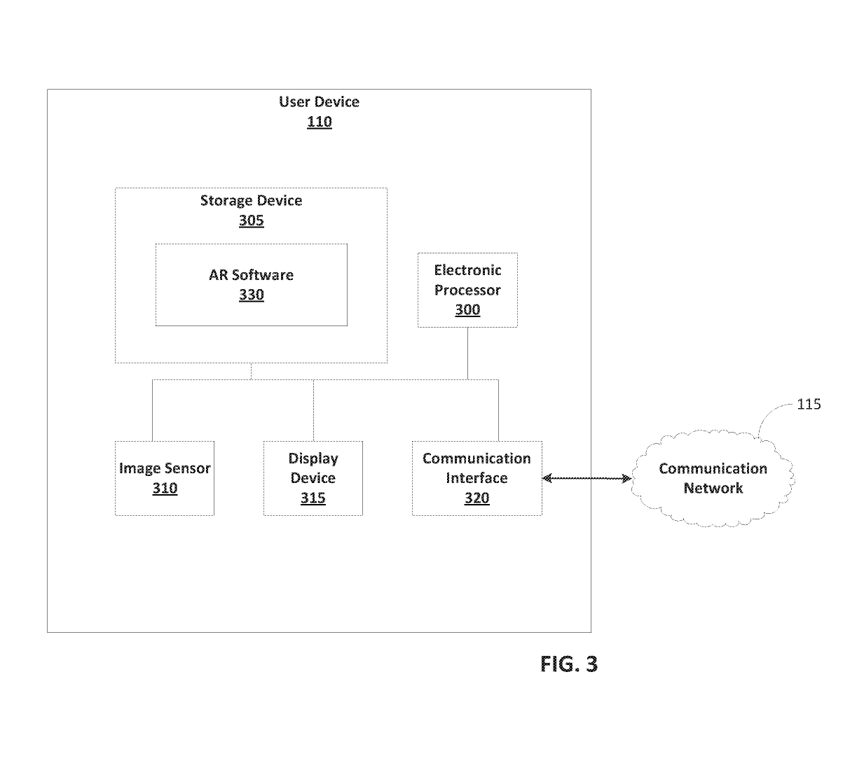

As illustrated in FIG. 3, a user device 110 is an electronic device, such as a smart phone, a smart watch, a tablet computer, a laptop computer, mixed reality headsets, or the like, that includes an electronic processor 300 (for example, a microprocessor, application-specific integrated circuit (ASIC), or another suitable electronic device), a storage device 305 (for example, a non-transitory, computer-readable storage medium), an image sensor 310, a display device 315, and a communication interface 320 such as a transceiver, for communicating over the communication networks 115 and, optionally, one or more additional communication networks or connections. In some embodiments, the image sensor 310 is a camera, such as a video camera. The display device 315 may be, for example, a touchscreen, a liquid crystal display (“LCD”), a light-emitting diode (“LED”) display, an organic LED (“OLED”) display, an electroluminescent display (“ELD”), and the like. The electronic processor 300, the storage device 305, image sensor 310, display device 315, and the communication interface 320 communicate over one or more communication lines or buses. It should be understood that a user device 110 may include additional components than those illustrated in FIG. 3 in various configurations and may perform additional functionality than the functionality described in the present application.

The storage device 305 of the user device 110 stores augmented reality (AR) software 330. It should be understood that the AR software 330 may be stored or distributed among multiple storage devices 305 within the user device 110 and the functionality described herein as being performed by the AR software 330 may be combined and distributed in various configurations. The AR software 330 may also perform additional functionality than the functionality described in the present application. For example, in some embodiments, the AR software 330 is included within a camera or image processing application.

As described in more detail below, when executed by the electronic processor 300 of the user device 110, the AR software 330 captures an image feed (with the image sensor 310) and displays the image feed on the display device 315 of the user device 110. The AR software 330 also augments the image feed to include supplemental information regarding tabular data detected within the image feed. The AR software 330 may communicate with and interact with native AR tools on the user device 110 to create an augmented reality environment, such as when the user device provides one or more AR tool kits.

As described in more detail below, the AR software 330 may communicate with the server 105 (the OCR software 215, the calculation services software 220, and the AI engine 225) over the communication networks 115 to detect the tabular data and generate the supplemental information as described herein. As noted above, the functionality described herein as being provided by the OCR software 215, the calculation services software 220, the AI engine 225, or a combination thereof may be performed locally on the user device 110. As also noted above, in some embodiments, the AR software 330 is configured to communicate with separate servers or separate cloud services environments to access and interact with the OCR software 215, the calculation services software 220, the AI engine 225, or a combination thereof.

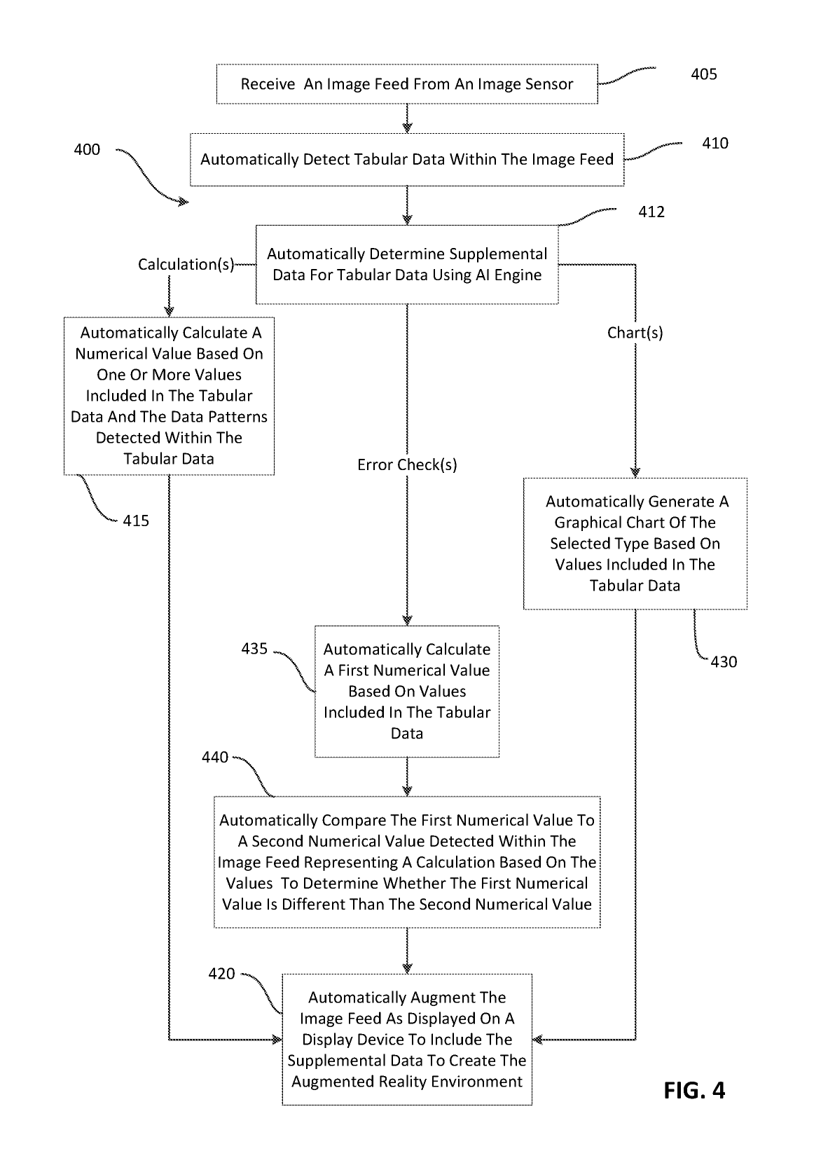

For example, FIG. 4 is a flow chart illustrating a method 400 of augmenting an image feed to create an augmented reality environment for tabular data included in the image feed. The method 400 is described as being performed by the system 100, and in particular, is described from the point of view of the user device 110 (the electronic processor 300 executing instructions, such as the AR software 330). However, as previously noted, this configuration is provided as one example and should not be considered limiting.

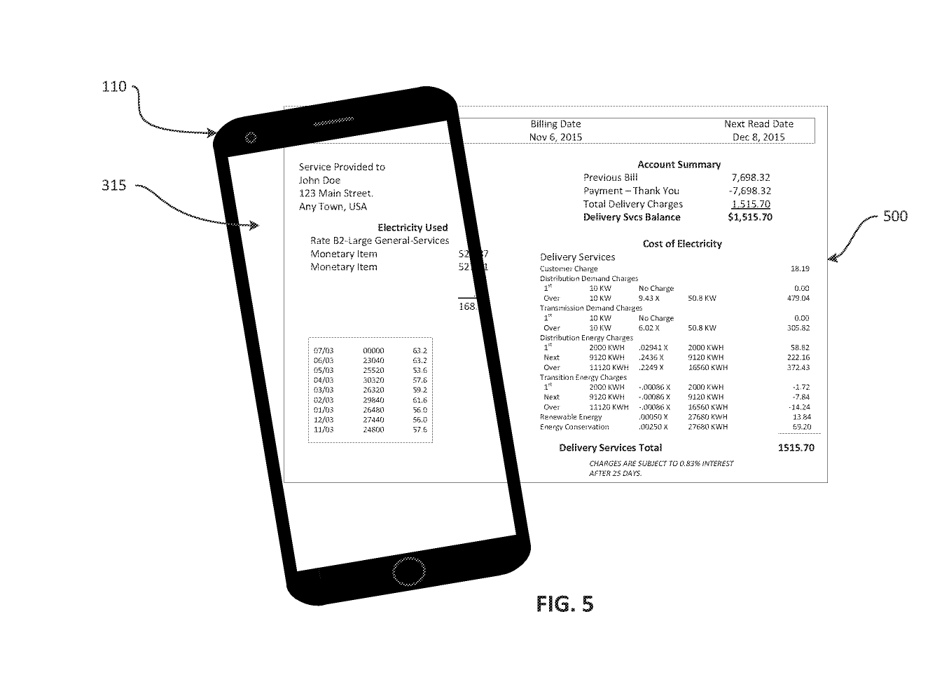

As illustrated in FIG. 4, the method 400 includes receiving, with the electronic processor 300, an image feed captured by the image sensor 310 (at block 405). For example, FIG. 5 illustrates an example user device 110, illustrated as a mobile phone. The user device 110 includes a display device 315, illustrated as a touchscreen, that displays an image feed captured by the image sensor 310 included in the user device 110. As illustrated in FIG. 5, the image feed includes data printed on an electricity bill 500.

Returning to FIG. 4, the electronic processor 300 automatically detects tabular data within the image feed (at block 410). To detect the tabular data, the electronic processor 300 may submit the image feed to the server 105 and, in particular, to the OCR software 215, via the communication networks 115. The OCR software 215 may be configured to detect the tabular data by detecting at least one gridline within the image feed, which are sometimes used to designate rows and columns of tabular data. Alternatively or in addition, the OCR software 215 may be configured to detect the tabular data by detecting data, such as numerical values, arranged horizontally, vertically, or a combination thereof within the image feed. In some embodiments, a user may also indicate, through the user device 110, portions of the image feed where tabular data may be located. For example, the AR software 330 may be configured to allow a user to select or designate tabular data within an image feed, by positioning a box or outline on the image feed, circling potential tabular data with a free-form line, or the like and this user input may be submitted to the OCR software 215 with the image feed.

The OCR software 215 returns the results of processing the image feed to the electronic processor 300 of the user device 110. The results may include a data set or structure (a table) of values detected within the image feed. In some embodiments, the results also include positional information that identifies where (for example, in pixel coordinates) within the image feed the tabular data (or individual values included in the tabular data) was detected. In some embodiments, the results from the OCR software also include other objects detected within the image feed (characters, shapes, people, and the like), such as any headers or characters associated with detected values within the tabular data.

The electronic processor 300 included in the user device 110 processes the results from the OCR software 215 to automatically determine a type of supplemental information to generate for the detected tabular data (at block 412). To determine the type of supplemental information to generate, the electronic processor 300 may submit the detected tabular data (as a data set) to the server 105 and, in particular, to the AI engine 225, via the communication networks 115. As noted above, the AI engine 225 is trained (and continues to learn) to detect patterns (including characteristics of individual values) within the detected tabular data, such as relationships between values within detected tabular data (identifying a sum or a sub total in the tabular data), a structure of the tabular data, tabular data that represents a bill or a receipt, and the like and develop rules that map these data patterns to particular supplemental information. The rules may be based on the type of values included in the detected tabular data, a number of values included in the detected tabular data, a type of value included in the tabular data (currency values, percentages, counts, and the like), an identifier of the user operating the user device 110, the user device 110, other data detected in the image feed (headers, titles, keywords), or the like. For example, when tabular data includes monetary values, a rule may indicate that a sum should be calculated. Similarly, when tabular data includes values associated different time periods, such as monthly electricity usage, a rule may indicate that an average should be calculated or a line graph should be generated. In addition, a rule may specify a particular type of calculation for image feeds submitted by a particular user or a user included in a particular group of users.

As noted above, in some embodiments, the AI engine 225 automatically develops the rules over time using machine learning. For example, in one embodiment, the AI engine 225 may be configured to generate a default set of supplemental information and may make all of the calculations available for selection or viewing by a user. The AI engine 225 may then use the user's feedback and selections to automatically develop or learn, using a neural network or other machine learning techniques, rules that map particular types of supplemental information to particular types of tabular data.

The results returned to the electronic processor 300 from the AI engine 225 may include a list of one or more types of supplemental information (a calculation, a graphic chart, or the like), the values to use for each type of supplemental information, and other parameters for the supplemental information, such as a specific type of graphical chart to generate, a specific type of calculation to perform, or the like. It should be understood that, in some embodiments, in addition to or as an alternative to using the AI engine 225, a user may be able to manually specify (by providing user input to the AR software 330) a type of supplemental information to generate, values to use to generate the supplemental information, other parameters for the supplemental information, or a combination thereof. These initial manual selections may similarly be used to train the AI engine 225 as described above.

As illustrated in FIG. 4, the results returned from AI engine 225 may instruct the electronic processor 300 to generate supplemental information for the detected tabular data by automatically calculating one or more numerical values based on the detected tabular data (at block 415), such as, for example, a sum, an average, a maximum, a minimum, a median, or a combination thereof. The electronic processor 300 may calculate these values by submitting the tabular data to the server 105 and, in particular, the calculation services software 220, for processing. As noted above, the calculation services software 220 may include the Excel® API provided by Microsoft Corporation that exposes functionality available with Excel®, such as calculations (functions), charts (including pivot tables), and the like. Accordingly, the calculation services software 220 may be configured to provide results to the AR software 330 including numerical data and, optionally images (graphical charts), in response to requests or “questions” from the AR software 330. Thus, the OCR software 215 detects tabular data in an image feed, and the AI engine 225 formulates a question to ask the calculation services software 220 based on the detected tabular data.

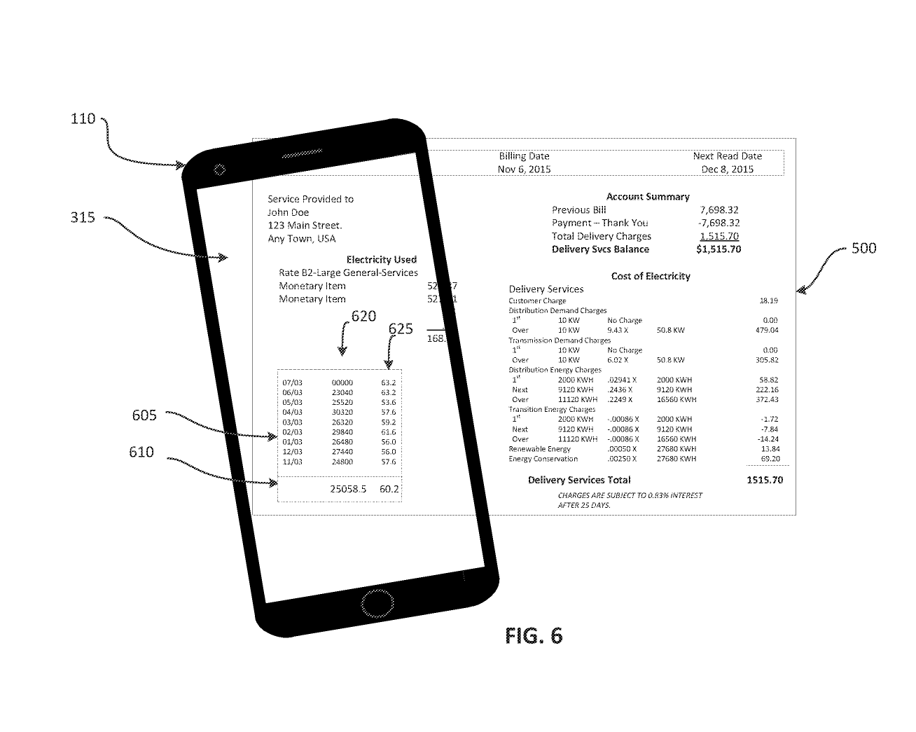

Based on the results from the calculation services software 220, the electronic processor 300 automatically augments the image feed to create an augmented reality environment using the generated supplemental information (at block 420). For example, when the results include one or more calculated values, the electronic processor 300 superimposes the calculated values (for example, as an image) on the image feed displayed on the user device 110 to create the augmented reality environment for the detected tabular data. In some embodiments the electronic processor 300 displays the calculated values within an additional row or column of the tabular data. In some embodiments, the electronic processor 300 also marks the set of tabular data used to calculate the calculated values, such as by highlighting, coloring, shading, outlining, or the like, one or more values included in the tabular data. For example, FIG. 6 illustrates the image feed of FIG. 5 augmented so tabular data 605 detected within the image feed includes an additional row 610 with two calculated values. The calculated values in the additional row 610 are the averages of the numerical values in the preceding rows of the two rightmost columns 620 and 625. As also illustrated in FIG. 6, the set of tabular data 605 and the additional row 610 have been marked (for example, outlined with a similar color or patterned line) in the same manner to indicate that the numerical values in the additional row 610 were calculated based on the tabular data 605. As noted above, in some embodiments, the AR software 330 may communicate with and interact with native AR tools installed on the user device 110 to create the augmented reality environment.

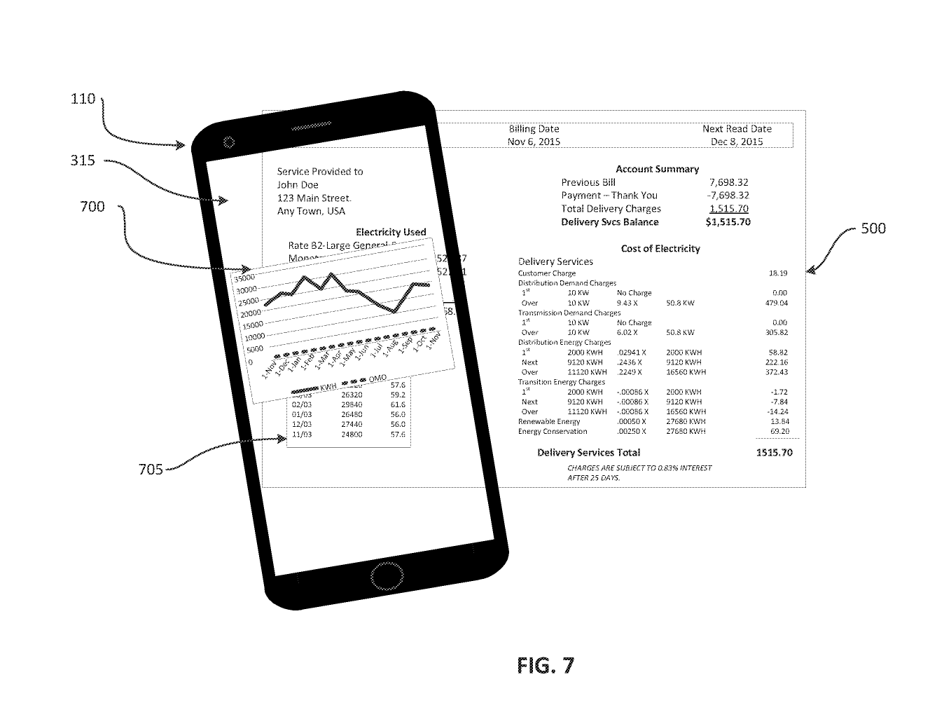

As illustrated in FIG. 4, the results returned from the AI engine 225 may similarly instruct the electronic processor 300 to generate supplemental information for the detected tabular data by generating a graphical chart for detected tabular data. The results may also specify the values to use for the graphical chart, a type of chart, headers or titles for the chart, and the like (block 425). Thus, based on these results from the AI engine 225 and the AR software 330 the electronic processor 300 automatically generates a graphical chart of the selected type based on values included in the tabular data (at block 430). As noted above, the electronic processor 200 may perform this processing by submitting the detected tabular data to the server 105 and, in particular, the calculation services software 220. The calculation services software 220 may return the generated chart as an image. However, in other embodiments, the calculation services software 220 may return the generated chart as a data set and the AR software 330 may use chart rendering software to convert the data set into an image. Thus, using the results from the calculation services software 220, the electronic processor 300 automatically augments the image feed to create an augmented reality environment (at block 420). In particular, the electronic processor 300 creates the augmented reality environment by superimposing the generated chart on the image feed. . In some embodiments, the electronic processor 300 also marks the tabular data used to create the graphical chart in the same manner. For example, the electronic processor 300 may highlight the tabular data used to create the chart with a color, pattern, or the like and use a similar highlighting on the associated graphical chart. As an example, FIG. 7 illustrates an image feed augmented to include a graphical chart 700. The graphical chart 700 illustrates the rise and fall of electricity consumption for each month of a given year based on the tabular data 705.

As illustrated in FIG. 4, the results returned from the AI engine 225 may similarly instruct the electronic processor 300 to generate supplemental information for the detected tabular data by validating, or performing an error check on, a calculation detected within the image feed, such as one or more calculations included in detected tabular data (for example, a column of sums or subtotals). In this embodiment, the electronic processor 300 uses the results from the AI engine 225 to automatically calculate a first numerical value based on one or more values included in the tabular data (block 435) and automatically compare the first numerical value to a second numerical value detected in the image feed (and identified by the AI engine 225) representing a calculation based on the same values to determine whether the second numerical value is correct or an error (block 445). The formula used to calculate the first numerical value may include a mathematical function (sum, average, and the like), a formula or function detected within the image feed, or a combination thereof. As noted above, the electronic processor 300 may perform this processing by submitting the detected tabular data to the calculation services software 220 with a request for a calculation to be performed based on the tabular data. In some embodiments, the calculation services software 220 may calculate the first numerical value and may also compare the first numerical value to the second numerical value. However, in other embodiments, the AR software 330 may use the calculation services software 220 to calculate the first numerical value and may then compare the first numerical value and the second numerical value. Thus, the results received by the electronic processor 300 may include the first numerical value, the results of comparing the first numerical value and the second numerical value, or a combination thereof.

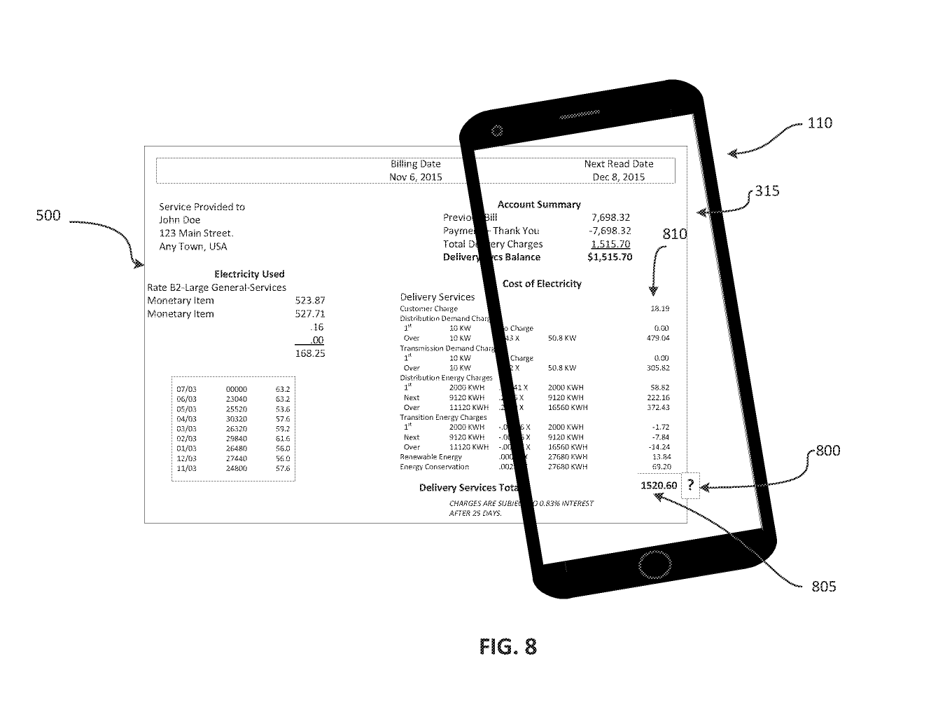

Based on the results from the calculation services software 220, the electronic processor 300, executing the AR software 330, augments the image feed to create an augmented reality environment (at block 420). For example, when the results indicate that the first numerical value does not match the second numerical value (the tabular data includes an error), the electronic processor 300 may mark (highlight) the second numerical value (the error) by superimposing data (an image) on the image feed to create the augmented reality environment for the detected tabular data. The superimposed data may include the first numerical value (the correct value), an error symbol or description (the character “?,” the word “ERROR,” or the like), or a combination thereof. In some embodiments the superimposed data is positioned adjacent to the second numerical value within the image feed, the tabular data within the image feed used to calculate the first numerical value, or the like. The electronic processor 300 may also augment the image feed to mark the second numerical value that was verified or identified as a potential error. For example, FIG. 8 illustrates an example image feed augmented, with a marking 800, to show that a second numerical value 805 included in the tabular data 955 (1520.70) may be an error because the second numerical value 805 differs from a value calculated from the actual values in the detected tabular data 810.

Accordingly, embodiments described herein create an augmented reality environment for tabular data captured in an image feed to provide supplemental information regarding the tabular data, including, for example, graphical charts, calculated values, errors, and the like. Thus, a user can quickly (in real-time) receive additional information for tabular data printed on paper, such as bills and receipts, written on whiteboards, and displayed on other display devices, including electronic signs and the like, without having to manually enter the tabular data into a spreadsheet application existing separate from the user's real-world view of the tabular data. Therefore, a user can point a camera included in a user device at a restaurant receipt and quickly obtain a total for the bill, verify that the bill was calculated correctly, calculate a suggested tip, identify how the bill could be split among multiple payers, determine a percentage of the bill represented by individual items on the bill, and the like. Again, the AR software 330 detects the tabular data in an image feed (using an OCR API), automatically detects detect patterns in the detected tabular data, automatically determines types of supplemental information to generate for the tabular data based on the detected data patterns (using an AI engine), and generates the supplemental information (using a calculation service). The augmented image may include calculated values, graphical charts, or even text-based insights, such as “Product X accounts for Y % of your bill.”

As illustrated in FIG. 4, it should be understood that the different types of supplemental information and resulting augmentations described above may be applied individually or in combination for a particular image feed. Also, where more than one augmentation is generated for a particular image feed, the augmentations may be performed in parallel on the same image feed or may be performed independently. Also, the particular types of augmentation applied to a particular image feed may be specified by a user. For example a user may indicate, via user input, that the electronic processor 300 should only augment the image to include a graphical chart.

Similarly, it should be understood that the functionality described above may be applied to one set of tabular data or multiple sets of tabular data within an image feed. For example, sets of tabular data may be identified (for example, via the OCR software 215) based on their positions, alignments, types of data, number of rows, columns, and the like, and separate augmentations may be provided for each set of tabular data.

Also, in addition to augmenting the image feed as described above, the data used to augment the image feed may be provided to the user device 110 (the electronic processor 300) in various forms. For example, an electronic spreadsheet file may be generated (for example, by the OCR software 215 or the calculation services software 220) based on the tabular data and provided to the user device 110. The user device 110 can access the electronic spreadsheet file (through a spreadsheet application stored on the user device 110) to further manipulate the data as necessary. This file may be provided directly to the user device 110 or stored to a cloud storage system accessible by the user device. For example, a user may be able to select (pin) an augmentation displayed within the image feed to access the tabular data and other data used to generate the augmentation. In particular, selecting or pinning the augmentation may display the augmentation separate from the AR software or may send the augmentation (or data used to generate the augmentation) to a spreadsheet application for saving and subsequent use and manipulation.

Also, although the functionality described herein is described as using an image feed, similar functionality may also be provided for still images to provide supplemental information for tabular data captured in one or a plurality of still images.

Various features and advantages of some embodiments are set forth in the following claims.

What is claimed is:

1. An electronic device comprising:
an image sensor;
a display device; and
an electronic processor configured to:
receive an image feed from the image sensor;
automatically detect tabular data within the image feed;
automatically, via an artificial intelligence engine, determine a type of supplemental information to generate based on the tabular data, the type of supplemental information including at least one selected from a group consisting of a calculation and a graphical chart;
automatically generate supplemental information based on the determined type of supplemental information and at least one value included in the tabular data; and
automatically augment the image feed as displayed on the display device to include the supplemental information to create an augmented reality environment.

2. The electronic device according to claim 1, wherein the determined type of supplemental information is a calculation and wherein the electronic processor is configured to automatically generate the supplemental information by calculating a first numerical value based on the at least one value included in the tabular data.

3. The electronic device according to claim 2, wherein the electronic processor is configured to automatically augment the image feed by superimposing the first numerical value on the image feed.

4. The electronic device according to claim 2, wherein calculating the first numerical value includes calculating the first numerical value based on the at least one value included in the tabular data and at least one formula detected within the image feed.

5. The electronic device according to claim 2, wherein the electronic processor is configured to automatically augment the image feed by marking a second numerical value detected within the image feed when the second numerical value differs from the first numerical value.

6. The electronic device according to claim 1, wherein the determined type of supplemental information is a graphical chart and wherein the electronic process is configured to automatically generate the supplemental information by generating the graphical chart and automatically augment the image feed by superimposing the graphical chart on the image feed.

7. A method of creating an augmented reality environment for tabular data in an image feed, the method comprising:
receiving, with an electronic processor included in a user device, the image feed from an image sensor included in the user device;
automatically detecting tabular data within the image feed;
automatically detecting data patterns within the tabular data;
automatically calculating a numerical value based on one or more values included in the tabular data and the data patterns detected within the tabular data; and
automatically augmenting, with the electronic processor, the image feed as displayed on a display device of the user device to include the numerical value to create the augmented reality environment.

8. The method according to claim 7, wherein automatically detecting the tabular data within the image feed includes using an optical character recognition web service.

9. The method according to claim 7, wherein automatically detecting the tabular data within the image feed includes automatically detecting at least one gridline within the image feed.

10. The method according to claim 7, wherein automatically detecting the tabular data within the image feed includes automatically detecting a plurality of numerical values positioned in a row within the image feed.

11. The method according to claim 7, wherein automatically detecting the tabular data within the image feed includes automatically detecting a plurality of numerical values positioned in a column within the image feed.

12. The method according to claim 7, wherein automatically processing the tabular data to calculate the numerical value based on the tabular data includes using a calculation services web service.

13. The method according to claim 7, where automatically calculating the numerical value includes calculating at least one selected from a group consisting of a sum, an average, a maximum, a minimum, and a median.

14. The method according to claim 7, wherein automatically augmenting the image feed as displayed on the display device of the user device to include the numerical value includes superimposing at least one selected from a group consisting of a row and a column to the tabular data for displaying the numerical value.

15. Non-transitory computer-readable medium storing instructions that, when executed with an electronic processor, perform a set of functions, the set of functions comprising:
receiving tabular data detected within an image feed captured by an image sensor included in a user device;
automatically selecting a type of graphical chart from a plurality of graphical chart types based on a rule and the tabular data;
automatically generating a graphical chart of the type of graphical chart selected from the plurality of graphical chart types based on values included in the tabular data; and
automatically providing the graphical chart to the user device for augmenting the image feed as displayed on a display device of the user device to include the graphical chart to create an augmented reality environment.

16. The non-transitory computer-readable medium according to claim 15, wherein the set of functions further comprises automatically generating an electronic spreadsheet file based on the tabular data and providing the electronic spreadsheet file to the user device.

17. The non-transitory computer-readable medium according to claim 15, wherein automatically selecting the type of graphical chart from the plurality of graphical chart types based on the rule and the tabular data includes determining at least one selected from a group consisting of a type of data included in the tabular data, a header associated with the tabular data, and a number of values included in the tabular data.

18. The non-transitory computer-readable medium according to claim 15, wherein augmenting the image feed as displayed on the display device of the user device to include the graphical chart to create the augmented reality environment includes displaying the graphical chart as an image superimposed on the image feed displayed on the display device.

19. The non-transitory computer-readable medium according to claim 15, wherein augmenting the image feed as displayed on the display device of the user device to include the graphical chart to create the augmented reality environment includes marking the tabular data.
